(19) United States
(12) Patent Application Publication
(10) Pub. No.: US 2005/0049526 A1
(43) Pub. Date: Mar. 3, 2005

(54) Massage devices and methods thereof

(76) Inventor: Mark P. Baer, Las Vegas, NV (US)

Correspondence Address: WEISS & MOY PC, 4204 NORTH BROWN AVENUE, SCOTTSDALE, AZ, 85251, US

(21) Appl. No.: 10/653,178

(22) Filed: Sep. 3, 2003

(51) Int. Cl. A61H 7/00

(52) U.S. Cl. 601/15; 601/135; 601/137

(57) ABSTRACT

Improved massage devices are disclosed. The massage devices comprise a housing having a hollow chamber for containing a fluid. The housing comprises a first member, an opposite second member and a plurality of lobes. Each one of the plurality of lobes has a hollow portion. Each one of the plurality of lobes is coupled to the first member and the opposite second member. A portion of the first member defines a plurality of protuberances. An inner portion of the first member and an inner portion of the second member define a gap located between the first member and the second member. The hollow chamber is defined by the gap and the contiguous hollow portion of each one of the plurality of lobes. The fluid contained in the housing of the massage devices is heated or cooled to produce enhanced massaging relief for a body of a person.

### FIELD OF THE INVENTION

This invention relates generally to hand held massagers and more particularly to heating or cooling massage devices and methods thereof.

### BACKGROUND OF THE INVENTION

In the past, numerous massagers have been available. Typically, such massagers have been driven by an electric motor to produce pulsating or vibrating action, thereby relieving muscle tension. Numerous hand held massagers that impart a single motion and include a rolling or rubbing surface have also been disclosed.

More recently, York, U.S. Pat. No. 6,241,696 disclosed a hand held massage implement comprising a number of rotating balls fitted into a grip. Winger, U.S. Pat. No. 6,102,876 disclosed a hand held massager comprising a rod with movable contacts fixed at opposite ends of the rod, where the contact elements are used to engage a person's body in a number of different ways while at least one contact is held and manipulated by a user of the hand held massager. Neither York's '696 nor Winger's patent '876 suggest a device that produces heating or cooling for the portion of a person's body that is massaged during use of the hand held massager.

Owens, U.S. Pat. No. 5,817,149 discloses a therapeutic pad for heating or cooling a person's body. Owens '149 patent suggests the use of the therapeutic pad in combination with an electric massager or vibrator having a substantially flat face.

It is desirable to provide massage devices that may produce heating or cooling during use of the massage devices. As discussed above, current devices and methods are not available.

For the foregoing reasons, there is a need to provide improved heating or cooling massage devices and methods thereof. This invention provides massage devices that have a hollow chamber for containing fluids to warm or cool a person's body during use of the massage devices.

### SUMMARY OF THE INVENTION Accordingly, it is an object of this invention to provide improved massage devices.

It is a further object of this invention to provide improved massage devices having a hollow chamber for containing a fluid that produce warming or cooling of a portion of a body of a person when the massage devices contact the portion of the body of the person.

It is yet a still further object of this invention to provide methods for using improved massage devices.

It is a further object of this invention to provide methods for using improved massage devices to relieve muscular tension by means of warming or cooling of a portion of the body of the person when the massage devices contact the portion of the body of the person.

### PREFERRED EMBODIMENTS OF THE INVENTION

In accordance with one embodiment of this invention, a hand-held massage device for manipulation by a user to massage a portion of a body of a person is disclosed. The hand-held massage device comprises, in combination a housing having a hollow chamber for containing a fluid, a fluid located in the hollow chamber, the fluid being one of a warming fluid and a cooling fluid, so that the housing selectively produces one of warming of the portion of the body of the person when the massage device contacts the body of the person after the fluid of the massage device is warmed by the user and cooling of the portion of the body of the person when the massage device contacts the body of the person after the fluid of the massage device is cooled by the user.

The housing comprises a first member and an opposite second member, an inner portion of the first member and an inner portion of the opposite second member having a gap located between the first member and the opposite second member; an outer portion of the first member having a plurality of protuberances, the inner portion of the first member having a plurality of indentations corresponding to the plurality of protuberances so that the fluid flows into the plurality of indentations and into the gap. The housing further comprises a plurality of lobes, the housing having a plurality of corners, each one of the plurality of lobes located at each one of the plurality of corners and each one of an outer portion of the plurality of lobes coupled to an outer portion of the first member and an outer portion of the opposite second member.

Each one of the plurality of lobes has a hollow portion, an inner portion of each one of the lobes coupled to each one of an inner portion of the first member and the opposite second member so that the fluid flows into the gap located between the first member and the opposite second member and into the hollow portion of the plurality of lobes. The hollow chamber of the housing comprises the gap located between the first member and the opposite second member, the plurality of indentations of the first member and the hollow portion of each one of the plurality of lobes.

Both the first member and the opposite second member have a substantially oblong and curved shape so that the first member has substantially the same curvature as the opposite second member. Each one of the plurality of lobes along a longer edge of the first member and the opposite second member is larger than each one of the plurality of lobes along an opposite shorter edge of the first member and the opposite second member.

The hand-held massage device further comprises a valve in a portion of the housing for injecting the fluid into the hollow chamber of the housing. The valve comprises a self healing membrane. The housing comprises a plastic. The housing comprises a thermoplastic. The fluid comprises a high heat capacity solution heated to provide a warming effect. The fluid comprises a high heat capacity solution cooled to provide a cooling effect on using the massage device.

In accordance with a second embodiment of this invention, a massage device for manipulation by a user to massage a portion of a body of a person is disclosed. The massage device comprises, in combination a housing having a hollow chamber for containing a fluid, a fluid located in the hollow chamber, the fluid being one of a warming fluid and a cooling fluid, so that the housing selectively produces one of warming of the portion of the body of the person when the massage device contacts the body of the person after the fluid of the massage device is warmed by the user and cooling of the portion of the body of the person when the massage device contacts the body of the person after the fluid of the massage device is cooled by the user.

The housing comprises a first member and an opposite second member, an inner portion of the first member and an inner portion of the opposite second member having a gap located between the first member and the opposite second member; an outer portion of the first member having a plurality of protuberances, the inner portion of the first member having a plurality of indentations corresponding to the plurality of protuberances so that the fluid flows into the plurality of indentations and into the gap; and the housing comprising a plurality of lobes, the housing having a plurality of corners, each one of the plurality of lobes located at each one of the plurality of corners and each one of an outer portion of the plurality of lobes coupled to an outer portion of the first member and an outer portion of the opposite second member.

Each one of the plurality of lobes has a hollow portion, an inner portion of each one of the lobes coupled to each one of an inner portion of the first member and the opposite second member so that the fluid flows into the gap located between the first member and the opposite second member and into the hollow portion of the plurality of lobes; the hollow chamber of the housing comprises the gap located between the first member and the opposite second member, the plurality of indentations of the first member and the hollow portion of each one of the plurality of lobes; a valve in a portion of the housing for injecting the fluid into the hollow chamber of the housing; both the first member and the opposite second member have a substantially oblong and curved shape so that the first member has substantially the same curvature as the opposite second member; and each one of the plurality of lobes along a longer edge of the first member and the opposite second member is larger than each one of the plurality of lobes along an opposite shorter edge of the first member and the opposite second member.

In accordance with a third embodiment of this invention, a method for manipulating a hand-held massage device by a user massaging a portion of a body of a person is disclosed. The method comprises the steps of providing a housing having a hollow chamber for containing a fluid; providing a fluid located in the hollow chamber, the fluid being one of a warming fluid and a cooling fluid; and the housing selectively producing one of warming of the portion of the body of the person when the massage device contacts the body of the person after the fluid of the massage device is warmed by the user and cooling of the portion of the body of the person when the massage device contacts the body of the person after the fluid of the massage device is cooled by the user.

The method further comprises providing the housing comprises a first member and an opposite second member, an inner portion of the first member and an inner portion of the opposite second member having a gap located between the first member and the opposite second member, an outer portion of the first member having a plurality of protuberances, the inner portion of the first member having a plurality of indentations corresponding to the plurality of protuberances so that the fluid flows into the plurality of indentations and into the gap; providing the housing comprises a plurality of lobes, the housing having a plurality of corners, each one of the plurality of lobes located at each one of the plurality of corners and each one of an outer portion of the plurality of lobes coupled to an outer portion of the first member and an outer portion of the opposite second member; providing each one of the plurality of lobes having a hollow portion, an inner portion of each one of the lobes coupled to each one of an inner portion of the first member and the opposite second member so that the fluid flows into the gap located between the first member and the opposite second member and into the hollow portion of the plurality of lobes; providing the hollow chamber of the housing comprises the gap located between the first member and the opposite second member, the plurality of indentations of the first member and the hollow portion of each one of the plurality of lobes; and providing a valve in a portion of the housing for injecting the fluid into the hollow chamber of the housing.

The method further comprises providing both the first member and the opposite second member have a substantially oblong and curved shape so that the first member has substantially the same curvature as the opposite second member; providing each one of the plurality of lobes along a longer edge of the first member and the opposite second member is larger than each one of the plurality of lobes along an opposite shorter edge of the first member and the opposite second member; providing the housing comprises a plastic; and providing the fluid comprises a high heat capacity solution.

In a fourth embodiment of this invention, a method for manipulating a massage device by a user massaging a portion of a body of a person is disclosed. The method comprises the steps of providing a housing having a hollow chamber for containing a fluid; providing a fluid located in the hollow chamber, the fluid being one of a warming fluid and a cooling fluid; and the housing selectively producing one of warming of the portion of the body of the person when the massage device contacts the body of the person after the fluid of the massage device is warmed by the user and cooling of the portion of the body of the person when the massage device contacts the body of the person after the fluid of the massage device is cooled by the user.

The method further comprises providing the housing comprises a first member and an opposite second member, an inner portion of the first member and an inner portion of the opposite second member having a gap located between the first member and the opposite second member, an outer portion of the first member having a plurality of protuberances, the inner portion of the first member having a plurality of indentations corresponding to the plurality of protuberances so that the fluid flows into the plurality of indentations and into the gap; providing the housing comprises a plurality of lobes, the housing having a plurality of corners, each one of the plurality of lobes located at each one of the plurality of corners and each one of an outer portion of the plurality of lobes coupled to an outer portion of the first member and an outer portion of the opposite second member; providing each one of the plurality of lobes having a hollow portion, an inner portion of each one of the lobes coupled to each one of an inner portion of the first member and the opposite second member so that the fluid flows into the gap located between the first member and the opposite second member and into the hollow portion of the plurality of lobes; providing the hollow chamber of the housing comprises the gap located between the first member and the opposite second member, the plurality of indentations of the first member and the hollow portion of each one of the plurality of lobes; and providing a valve in a portion of the housing for injecting the fluid into the hollow chamber of the housing.

The method further comprises providing both the first member and the opposite second member have a substantially oblong and curved shape so that the first member has substantially the same curvature as the opposite second member; providing each one of the plurality of lobes along a longer edge of the first member and the opposite second member is larger than each one of the plurality of lobes along an opposite shorter edge of the first member and the opposite second member; providing the housing comprises a plastic; and providing the fluid comprises a high heat capacity solution.

The foregoing and other objects, features, and advantages of the invention will be apparent from the following, more detailed description of the preferred embodiments of the invention, as illustrated in the accompanying drawings.

### BRIEF DESCRIPTION OF THE DRAWINGS

FIG. 1 is a perspective view of a massage device according to the invention;

FIG. 2 is a sectional view through 2-2 of the massage device of FIG. 1;

FIG. 3 is an elevation view of the massage device of FIG. 1; and

FIG. 4 is a perspective view of the massage device of FIG. 1 located in a hand of a user manipulating the massage device on a back portion of a person.

### DESCRIPTION OF THE INVENTION

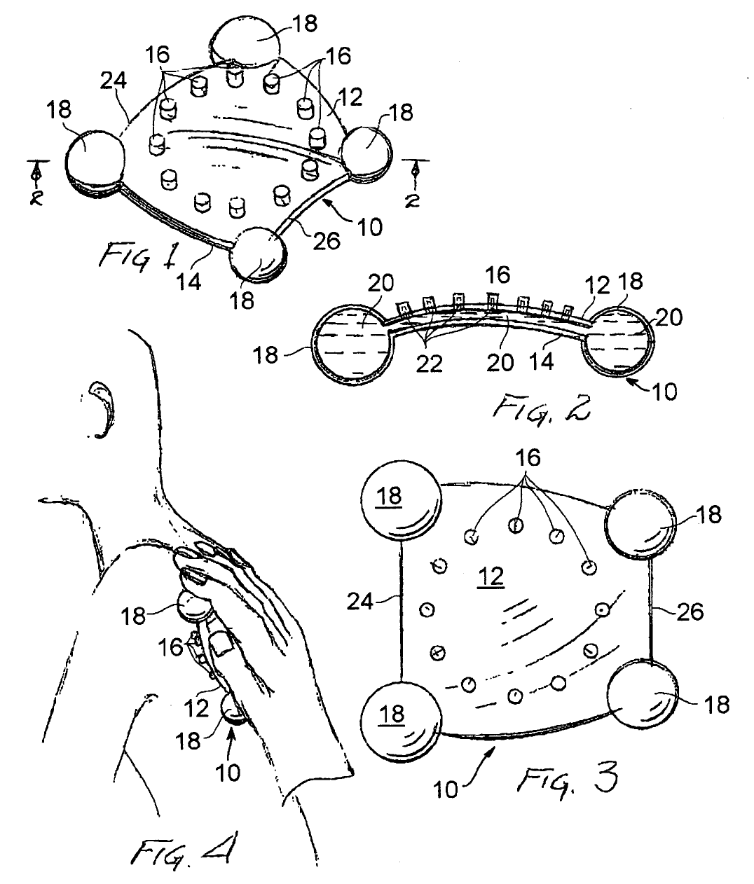

According to FIG. 1, a massage device comprises a housing 10 having a hollow chamber for containing a fluid 20. The housing 10 comprises a first member 12. The first member 12 has a substantially oblong and curved shape so that the first member 12 may comfortably fit into a hand of a user of the massage device. A portion of an outer surface of the first member 12 defines a plurality of protuberances 16. Each one of the plurality of protuberances 16 has a substantially cylindrical shape. A portion of an inner surface of the first member 12 defines a plurality of indentations 22. Each one of the plurality of indentations 22 corresponds to each one of the plurality of protuberances 16 and the fluid 20 flows into each one of the plurality of indentations 22. The housing 10 further comprises an opposite second member 14. The opposite second member 14 has a substantially oblong and curved shape. The opposite second member 14 has substantially the same curvature as the first member 12. The inner portion of the first member 12 and an inner portion of the opposite second member 14 define a gap so that the fluid 20 flows into a region located between the inner portion of the first member 12 and the inner portion of the member 14 as well as into the plurality of indentations 22. The housing 10 further comprises a plurality of lobes 18. An outer portion of each one of the plurality of lobes 18 is coupled to an outer portion of each one of a plurality of corners of the first member 12 and the opposite second member 14. Each one of the plurality of lobes 18 is substantially spherically shaped. An inner portion of each one of the plurality of lobes 18 is also coupled to an inner portion of each one of the plurality of corners of the first member 12 and the opposite second member 14. Each one of the plurality of lobes 18 defines a hollow portion so that the fluid 20 flows into the hollow portion of each one of the plurality of lobes 18 and into the gap located between the first member 12 and the opposite second member 14 as well as into the plurality of indentations 22. The housing 10 completely contains the fluid 20 (see FIGS. 1 and 2) since the hollow chamber comprises the inner portion of the first member 12, the inner portion of the opposite second member 14 and the hollow portion of each one of the plurality of lobes 18 which are contiguously coupled. It is understood that the complete housing 10 may be constructed in various ways to achieve the purpose of containing the fluid 20. The housing comprises a plastic. The plastic is preferably rigid. The housing preferably comprises a thermoplastic. It is understood that other materials could be used with equivalent results.

FIG. 2 is a sectional view through 2-2 of the housing 10 of the massage device. Referring to FIG. 2, the housing 10 contains the fluid 20 in the hollow chamber as described supra. The fluid 20 comprises a high heat capacity solution which provides a warming effect on a portion of a body of a person after heating the housing 10 when the massage device is used or a cooling effect on a portion of the body of a person after cooling the housing 10 when the massage device is used. Typically the fluid filled massage device is heated in a microwave oven or cooled in a refrigerator prior to use. An example of a suitable fluid 20 is a polyacrylamide in water. The fluid 20 may be introduced into the housing 10 of the massage device by injection through a suitable valve in a portion of the housing 10. An example of a suitable valve is a self-healing membrane. It is understood that numerous equivalents for introducing the fluid 20 into the housing 10 exist. The fluid 20 may also be removed and replaced by another fluid 20 as desired.

FIG. 3 is an elevation view of the massage device showing the features described supra in better detail. While the plurality of protuberances 16 are shown substantially circularly disposed on a portion of the first member 12, it is understood that the plurality of protuberances 16 may be irregularly disposed on the portion of the first member 12. It is understood that the plurality of lobes 18 may be of different size. It is preferable that the plurality of lobes 18 located at the corners of a longer edge 24 of the first member 12 are larger than the plurality of lobes 18 located at the corners of an opposite shorter edge 26 of the first member 12. Different sizes of the plurality of lobes 18 allows for improved flexibility in massaging of different portions of the body of the person. The massage device tapers from the longer edge 24 to the opposite shorter edge 26 allowing easier manipulation of the massage device by a user.

Referring to FIG. 4 a perspective view of the massage device is shown located in a hand of a user manipulating the massage device on a back portion of a person. As shown in FIG. 4, the plurality of protuberances 16 and the plurality of lobes 18 contact the back portion of the person. The hand of the user manipulates the massage device by moving a portion of the opposite second member 14 of the massage device. The massage device may also be reversed so that the plurality of lobes 18 contacts a portion of the body of the person. In this case the hand of the user manipulates the massage device by moving a portion of the first member 12 of the massage device. Since the fluid 20 in the housing 10 of the massage device may be warmed or cooled, the massage device produces an enhanced massaging experience. In principle an edge of the massage device may also be held by the hand of the user with at least one of the plurality of lobes 18 contacting a portion of the body of the person. It is understood that the massage device may be used on any suitable portion of the body of the person. It is understood that the user of the massage device may be the person receiving the massage.

In summary, improved massage devices comprise a housing having a hollow chamber for containing a fluid. The housing comprises a first member, an opposite second member and a plurality of lobes. Each one of the plurality of lobes has a hollow portion. Each one of the plurality of lobes is coupled to the first member and the opposite second member. A portion of the first member defines a plurality of protuberances. An inner portion of the first member and an inner portion of the second member define a gap located between the first member and the second member. The hollow chamber is defined by the gap and the contiguous hollow portion of each one of the plurality of lobes. The fluid contained in the housing of the massage devices is heated or cooled to produce enhanced massaging relief for a body of a person.

While the invention has been particularly shown and described with reference to preferred embodiments thereof, it will be understood by those skilled in the art that the foregoing and other changes in form and details may be made therein without departing from the spirit and scope of the invention. For example, the shape and sizes of the plurality of protuberances may be altered. Massaging devices may be coated with a silicone or a fluoropolymer to allow smoother manipulation on a person's body. The fluid may be enclosed within a plurality of flexible containers contained in a hollow chamber of the housing of massage devices. Massage devices may be coupled to power sources to produce automated massaging in addition to warming or cooling of a portion of a person's body that is massaged. It may be further preferred to have only the hollow portion each one of the plurality of lobes filled with a liquid, and each one of the plurality of the lobes may have an individual valve for filling the hollow portion of each one of the plurality of lobes.

1. A hand-held massage device for manipulation by a user to massage a portion of a body of a person comprising, in combination: a housing having a hollow chamber for containing a fluid, a fluid located in said hollow chamber, said fluid being one of a warming fluid and a cooling fluid, so that said housing selectively produces one of warming of the portion of the body of the person when the massage device contacts the body of the person after said fluid of the massage device is warmed by the user and cooling of the portion of the body of the person when the massage device contacts the body of the person after said fluid of the massage device is cooled by the user.

2. The hand-held massage device for manipulation by a user to massage a portion of a body of a person according to claim 1 wherein said housing comprising a first member and an opposite second member, an inner portion of said first member and an inner portion of said opposite second member having a gap located between said first member and said opposite second member; an outer portion of said first member having a plurality of protuberances, the inner portion of said first member having a plurality of indentations corresponding to said plurality of protuberances so that said fluid flows into said plurality of indentations and into the gap.

3. The hand-held massage device for manipulation by a user to massage a portion of a body of a person according to claim 2 wherein said housing comprising a plurality of lobes, said housing having a plurality of corners, each one of said plurality of lobes located at each one of the plurality of corners and each one of an outer portion of said plurality of lobes coupled to an outer portion of said first member and an outer portion of said opposite second member.

4. The hand-held massage device for manipulation by a user to massage a portion of a body of a person according to claim 3 wherein each one of said plurality of lobes having a hollow portion, an inner portion of each one of said lobes coupled to each one of an inner portion of said first member and said opposite second member so that said fluid flows into the gap located between said first member and said opposite second member and into the hollow portion of said plurality of lobes.

5. The hand-held massage device for manipulation by a user to massage a portion of a body of a person according to claim 4 wherein the hollow chamber of said housing comprising the gap located between said first member and said opposite second member, said plurality of indentations of said first member and the hollow portion of each one of said plurality of lobes.

6. The hand-held massage device for manipulation by a user to massage a portion of a body of a person according to claim 2 wherein both said first member and said opposite second member having a substantially oblong and curved shape so that said first member has substantially the same curvature as said opposite second member.

7. The hand-held massage device for manipulation by a user to massage a portion of a body of a person according to claim 3 wherein each one of said plurality of lobes along a longer edge of said first member and said opposite second member is larger than each one of said plurality of lobes along an opposite shorter edge of said first member and said opposite second member.

8. The hand-held massage device for manipulation by a user to massage a portion of a body of a person according to claim 1 further comprising a valve in a portion of said housing for injecting said fluid into the hollow chamber of said housing.

9. The hand-held massage device for manipulation by a user to massage a portion of a body of a person according to claim 8 wherein said valve comprises a self healing membrane.

10. The hand-held massage device for manipulation by a user to massage a portion of a body of a person according to claim 1 wherein said housing comprises a plastic.

11. The hand-held massage device for manipulation by a user to massage a portion of a body of a person according to claim 1 wherein said housing comprises a thermoplastic.

12. The hand-held massage device for manipulation by a user to massage a portion of a body of a person according to claim 1 wherein said fluid comprises a high heat capacity solution heated to provide a warming effect.

13. The hand-held massage device for manipulation by a user to massage a portion of a body of a person according to claim 1 wherein said fluid comprises a high heat capacity solution cooled to provide a cooling effect on using the massage device.

14. A massage device for manipulation by a user to massage a portion of a body of a person comprising, in combination: a housing having a hollow chamber for containing a fluid, a fluid located in said hollow chamber, said fluid being one of a warming fluid and a cooling fluid, so that said housing selectively produces one of warming of the portion of the body of the person when the massage device contacts the body of the person after said fluid of the massage device is warmed by the user and cooling of the portion of the body of the person when the massage device contacts the body of the person after said fluid of the massage device is cooled by the user.

15. The massage device for manipulation by a user to massage a portion of a body of a person according to claim 14 wherein said housing comprising a first member and an opposite second member, an inner portion of said first member and an inner portion of said opposite second member having a gap located between said first member and said opposite second member; an outer portion of said first member having a plurality of protuberances, the inner portion of said first member having a plurality of indentations corresponding to said plurality of protuberances so that said fluid flows into said plurality of indentations and into the gap; and said housing comprising a plurality of lobes, said housing having a plurality of corners, each one of said plurality of lobes located at each one of the plurality of corners and each one of an outer portion of said plurality of lobes coupled to an outer portion of said first member and an outer portion of said opposite second member.

16. The massage device for manipulation by a user to massage a portion of a body of a person according to claim 15 wherein each one of said plurality of lobes having a hollow portion, an inner portion of each one of said lobes coupled to each one of an inner portion of said first member and said opposite second member so that said fluid flows into the gap located between said first member and said opposite second member and into the hollow portion of said plurality of lobes; the hollow chamber of said housing comprising the gap located between said first member and said opposite second member, said plurality of indentations of said first member and the hollow portion of each one of said plurality of lobes; a valve in a portion of the housing for injecting the fluid into the hollow chamber of the housing; both said first member and said opposite second member having a substantially oblong and curved shape so that said first member has substantially the same curvature as said opposite second member; and each one of said plurality of lobes along a longer edge of said first member and said opposite second member is larger than each one of said plurality of lobes along an opposite shorter edge of said first member and said opposite second member.

17. A method for manipulating a hand-held massage device by a user massaging a portion of a body of a person comprising the steps of:
providing a housing having a hollow chamber for containing a fluid;
providing a fluid located in said hollow chamber, said fluid being one of a warming fluid and a cooling fluid; and
said housing selectively producing one of warming of the portion of the body of the person when the massage device contacts the body of the person after said fluid of the massage device is warmed by the user and cooling of the portion of the body of the person when the massage device contacts the body of the person after said fluid of the massage device is cooled by the user.

18. The method for manipulating a hand-held massage device by a user massaging a portion of a body of a person according to claim 17 further comprising the steps of:
providing said housing comprising a first member and an opposite second member, an inner portion of said first member and an inner portion of said opposite second member having a gap located between said first member and said opposite second member, an outer portion of said first member having a plurality of protuberances, the inner portion of said first member having a plurality of indentations corresponding to said plurality of protuberances so that said fluid flows into said plurality of indentations and into the gap;
providing said housing comprising a plurality of lobes, said housing having a plurality of corners, each one of said plurality of lobes located at each one of the plurality of corners and each one of an outer portion of said plurality of lobes coupled to an outer portion of said first member and an outer portion of said opposite second member;
providing each one of said plurality of lobes having a hollow portion, an inner portion of each one of said lobes coupled to each one of an inner portion of said first member and said opposite second member so that said fluid flows into the gap located between said first member and said opposite second member and into the hollow portion of said plurality of lobes;
providing the hollow chamber of said housing comprising the gap located between said first member and said opposite second member, said plurality of indentations of said first member and the hollow portion of each one of said plurality of lobes; and
providing a valve in a portion of said housing for injecting said fluid into the hollow chamber of said housing.

19. The method for manipulating a hand-held massage device by a user massaging a portion of a body of a person according to claim 18 further comprising the steps of:
providing both said first member and said opposite second member having a substantially oblong and curved shape so that said first member has substantially the same curvature as said opposite second member;
providing each one of said plurality of lobes along a longer edge of said first member and said opposite second member is larger than each one of said plurality of lobes along an opposite shorter edge of said first member and said opposite second member;
providing said housing comprises a plastic; and
providing said fluid comprises a high heat capacity solution.

20. A method for manipulating a massage device by a user massaging a portion of a body of a person comprising the steps of:
providing a housing having a hollow chamber for containing a fluid;
providing a fluid located in said hollow chamber, said fluid being one of a warming fluid and a cooling fluid; and
said housing selectively producing one of warming of the portion of the body of the person when the massage device contacts the body of the person after said fluid of the massage device is warmed by the user and cooling of the portion of the body of the person when the massage device contacts the body of the person after said fluid of the massage device is cooled by the user.

21. The method for manipulating a hand-held massage device by a user massaging a portion of a body of a person according to claim 20 further comprising the steps of:
providing said housing comprising a first member and an opposite second member, an inner portion of said first member and an inner portion of said opposite second member having a gap located between said first member and said opposite second member, an outer portion of said first member having a plurality of protuberances, the inner portion of said first member having a plurality of indentations corresponding to said plurality of protuberances so that said fluid flows into said plurality of indentations and into the gap;
providing said housing comprising a plurality of lobes, said housing having a plurality of corners, each one of said plurality of lobes located at each one of the plurality of corners and each one of an outer portion of said plurality of lobes coupled to an outer portion of said first member and an outer portion of said opposite second member;
providing each one of said plurality of lobes having a hollow portion, an inner portion of each one of said lobes coupled to each one of an inner portion of said first member and said opposite second member so that said fluid flows into the gap located between the first member and said opposite second member and into the hollow portion of said plurality of lobes;
providing the hollow chamber of said housing comprising the gap located between said first member and said opposite second member, said plurality of indentations of said first member and the hollow portion of each one of said plurality of lobes; and
providing a valve in a portion of said housing for injecting said fluid into the hollow chamber of said housing.

22. The method for manipulating a hand-held massage device by a user massaging a portion of a body of a person according to claim 21 further comprising the steps of:
providing both said first member and said opposite second member having a substantially oblong and curved shape so that said first member has substantially the same curvature as said opposite second member;
providing each one of said plurality of lobes along a longer edge of said first member and said opposite second member is larger than each one of said plurality of lobes along an opposite shorter edge of said first member and said opposite second member;
providing said housing comprises a plastic; and
providing said fluid comprises a high heat capacity solution.
